(19) United States
(12) Patent Application Publication
(10) Pub. No.: US 2026/0089718 A1
(43) Pub. Date: Mar. 26, 2026

(54) ENHANCEMENTS FOR UPLINK CONTROL CHANNELS

(71) Applicant: QUALCOMM Incorporated, San Diego, CA (US)

(72) Inventors: Kianoush HOSSEINI, San Diego, CA (US); Mostafa KHOSHNEVISAN, San Diego, CA (US); Gokul SRIDHARAN, Sunnyvale, CA (US); Gabi SARKIS, San Diego, CA (US)

(21) Appl. No.: 18/892,817

(22) Filed: Sep. 23, 2024

(51) Int. Cl. H04W 72/21; H04L 5/00

(52) U.S. Cl. CPC H04W 72/21; H04L 5/0051

(57) ABSTRACT

Some examples of the techniques described herein may provide a sounding reference signal (SRS) for a physical uplink shared channel (PUCCH). In some examples, a total bandwidth for the SRS with PUCCH may be limited to a quantity of resource blocks (RBs) supported across PUCCH formats. Additionally, or alternatively, the SRS for PUCCH may be located in one or more bands (e.g., band(s) at the edge(s) of a channel utilized for physical uplink shared channel (PUSCH) and PUCCH communication). The SRS for PUCCH may allow for antenna combining for the PUCCH, which may improve PUCCH reception performance. In some examples of utilizing an SRS for PUCCH, the SRS may be utilized to determine or provide a channel estimate with enhanced accuracy. In some examples, the SRS for PUCCH may have one or more resource sets.

### FIELD OF TECHNOLOGY

The following relates to wireless communications, including enhancements for uplink control channels.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method by a user equipment (UE) is described. The method may include transmitting, to a network entity, a sounding reference signal (SRS) associated with a physical uplink control channel (PUCCH) via one or more resource sets and transmitting, to the network entity, the PUCCH via at least one resource block (RB) within a quantity of RBs supported for one or more PUCCH formats.

A UE is described. The UE may include one or more memories storing processor executable code, and one or more processors coupled with the one or more memories. The one or more processors may individually or collectively be operable to execute the code to cause the UE to transmit, to a network entity, an SRS associated with a PUCCH via one or more resource sets and transmit, to the network entity, the PUCCH via at least one RB within a quantity of RBs supported for one or more PUCCH formats.

Another UE is described. The UE may include means for transmitting, to a network entity, an SRS associated with a PUCCH via one or more resource sets and means for transmitting, to the network entity, the PUCCH via at least one RB within a quantity of RBs supported for one or more PUCCH formats.

A non-transitory computer-readable medium storing code is described. The code may include instructions executable by one or more processors to transmit, to a network entity, an SRS associated with a PUCCH via one or more resource sets and transmit, to the network entity, the PUCCH via at least one RB within a quantity of RBs supported for one or more PUCCH formats.

In some examples of the method, UEs, and non-transitory computer-readable medium described herein, a bandwidth of the SRS associated with the PUCCH may be limited to the quantity of RBs supported for the one or more PUCCH formats.

In some examples of the method, UEs, and non-transitory computer-readable medium described herein, transmitting the SRS associated with the PUCCH may include operations, features, means, or instructions for transmitting the SRS via at least one RB that overlaps in frequency with the at least one RB utilized to communicate the PUCCH.

Some examples of the method, UEs, and non-transitory computer-readable medium described herein may further include operations, features, means, or instructions for receiving information indicating a configuration of the SRS associated with the PUCCH, where the SRS may be configured based on the quantity of RBs or one or more locations of one or more RBs for the PUCCH.

In some examples of the method, UEs, and non-transitory computer-readable medium described herein, the SRS may be independent of a second SRS associated with a physical uplink shared channel (PUSCH).

Some examples of the method, UEs, and non-transitory computer-readable medium described herein may further include operations, features, means, or instructions for receiving a transmitted precoding matrix indicator (TPMI) or a transmission configuration indicator (TCI) for the PUCCH, where the TPMI or TCI may be based on the SRS associated with the PUCCH.

Some examples of the method, UEs, and non-transitory computer-readable medium described herein may further include operations, features, means, or instructions for receiving a TPMI or a TCI for the PUCCH, where the TPMI or the TCI for the PUCCH may be received via downlink control information (DCI), and where a precoding matrix for the PUCCH may be independent from a precoding matrix for an PUSCH or may be equal to a precoding matrix for the PUSCH.

Some examples of the method, UEs, and non-transitory computer-readable medium described herein may further include operations, features, means, or instructions for transmitting, previous to transmitting the PUCCH, an PUSCH utilizing a port, where the PUCCH may be transmitted utilizing the port that was utilized for transmission of the PUSCH.

In some examples of the method, UEs, and non-transitory computer-readable medium described herein, transmitting the PUCCH may include operations, features, means, or instructions for transmitting the PUCCH based on a precoding matrix that varies based on a frequency associated with a resource element (RE), an RB, or a precoding resource block group (PRG).

Some examples of the method, UEs, and non-transitory computer-readable medium described herein may further include operations, features, means, or instructions for communicating an indication of a time delay across antennas for the PUCCH, where the time delay may be based on a PUCCH format, the quantity of RBs, or a payload of the PUCCH, and where the PUCCH may be transmitted based on the time delay.

Some examples of the method, UEs, and non-transitory computer-readable medium described herein may further include operations, features, means, or instructions for receiving a request for the indication of the time delay across the antennas for the PUCCH, where communicating the indication of the time delay may be based on the request.

In some examples of the method, UEs, and non-transitory computer-readable medium described herein, transmitting the PUCCH may include operations, features, means, or instructions for transmitting the PUCCH with a transmission scheme that may be based on a quantity of RBs utilized for transmission of the PUCCH.

Some examples of the method, UEs, and non-transitory computer-readable medium described herein may further include operations, features, means, or instructions for communicating an indication of a time delay across antennas for the SRS associated with the PUCCH, where the SRS and the PUCCH may be transmitted based on the time delay.

Some examples of the method, UEs, and non-transitory computer-readable medium described herein may further include operations, features, means, or instructions for transmitting a power headroom report (PHR) associated with the PUCCH, where the PHR may be independent from a PHR associated with a PUSCH.

Some examples of the method, UEs, and non-transitory computer-readable medium described herein may further include operations, features, means, or instructions for receiving a synchronization signal block (SSB) and transmitting, based on receiving the SSB, an indication of one or more recommended resources for transmitting the PUCCH, where the indication indicates a recommended quantity of repetitions for the PUCCH, one or more recommended PUCCH formats, a recommended quantity of symbols, or a recommended quantity of RBs.

A method by a network entity is described. The method may include obtaining, from a UE, an SRS associated with a PUCCH via one or more resource sets and obtaining, from the UE, the PUCCH via at least one RB within a quantity of RBs supported for one or more PUCCH formats.

A network entity is described. The network entity may include one or more memories storing processor executable code, and one or more processors coupled with the one or more memories. The one or more processors may individually or collectively be operable to execute the code to cause the network entity to obtain, from a UE, an SRS associated with a PUCCH via one or more resource sets and obtain, from the UE, the PUCCH via at least one RB within a quantity of RBs supported for one or more PUCCH formats.

Another network entity is described. The network entity may include means for obtaining, from a UE, an SRS associated with a PUCCH via one or more resource sets and means for obtaining, from the UE, the PUCCH via at least one RB within a quantity of RBs supported for one or more PUCCH formats.

A non-transitory computer-readable medium storing code is described. The code may include instructions executable by one or more processors to obtain, from a UE, an SRS associated with a PUCCH via one or more resource sets and obtain, from the UE, the PUCCH via at least one RB within a quantity of RBs supported for one or more PUCCH formats.

In some examples of the method, network entities, and non-transitory computer-readable medium described herein, a bandwidth of the SRS associated with the PUCCH may be limited to the quantity of RBs supported for one or more PUCCH formats.

In some examples of the method, network entities, and non-transitory computer-readable medium described herein, obtaining the SRS associated with the PUCCH may include operations, features, means, or instructions for obtaining the SRS via at least one RB that overlaps in frequency with the at least one RB utilized to communicate the PUCCH.

Some examples of the method, network entities, and non-transitory computer-readable medium described herein may further include operations, features, means, or instructions for outputting information indicating a configuration of the SRS associated with the PUCCH, where the SRS may be configured based on the quantity of RBs or one or more locations of one or more RBs for the PUCCH.

In some examples of the method, network entities, and non-transitory computer-readable medium described herein, the SRS may be independent of a second SRS associated with an PUSCH.

Some examples of the method, network entities, and non-transitory computer-readable medium described herein may further include operations, features, means, or instructions for outputting a TPMI or a TCI for the PUCCH, where the TPMI or TCI may be based on the SRS associated with the PUCCH.

Some examples of the method, network entities, and non-transitory computer-readable medium described herein may further include operations, features, means, or instructions for outputting a TPMI or a TCI for the PUCCH, where the TPMI or the TCI for the PUCCH may be received via DCI, and where a precoding matrix for the PUCCH may be independent from a precoding matrix for an PUSCH or may be equal to a precoding matrix for the PUSCH.

Some examples of the method, network entities, and non-transitory computer-readable medium described herein may further include operations, features, means, or instructions for obtaining, previous to obtaining the PUCCH, an PUSCH from a port, where the PUCCH may be received from the port that was utilized for the PUSCH.

In some examples of the method, network entities, and non-transitory computer-readable medium described herein, obtaining the PUCCH may include operations, features, means, or instructions for obtaining the PUCCH based on a precoding matrix that varies based on a frequency associated with an RE, an RB, or a PRG.

Some examples of the method, network entities, and non-transitory computer-readable medium described herein may further include operations, features, means, or instructions for communicating an indication of a time delay across antennas for the PUCCH, where the time delay may be based on a PUCCH format, the quantity of RBs, or a payload of the PUCCH, and where the PUCCH may be transmitted based on the time delay.

Some examples of the method, network entities, and non-transitory computer-readable medium described herein may further include operations, features, means, or instructions for outputting a request for the indication of the time delay across the antennas for the PUCCH, where communicating the indication of the time delay may be based on the request.

In some examples of the method, network entities, and non-transitory computer-readable medium described herein, obtaining the PUCCH may include operations, features, means, or instructions for obtaining the PUCCH with a transmission scheme that may be based on a quantity of RBs utilized for transmission of the PUCCH.

Some examples of the method, network entities, and non-transitory computer-readable medium described herein may further include operations, features, means, or instructions for communicating an indication of a time delay across antennas for the SRS associated with the PUCCH, where the SRS and the PUCCH may be transmitted based on the time delay.

Some examples of the method, network entities, and non-transitory computer-readable medium described herein may further include operations, features, means, or instructions for obtaining a power headroom report (PHR) associated with the PUCCH, where the PHR may be independent from a PHR associated with a PUSCH.

Some examples of the method, network entities, and non-transitory computer-readable medium described herein may further include operations, features, means, or instructions for outputting a synchronization signal block (SSB) and obtaining, based on outputting the SSB, an indication of one or more recommended resources for obtaining the PUCCH, where the indication indicates a recommended quantity of repetitions for the PUCCH, one or more recommended PUCCH formats, a recommended quantity of symbols, or a recommended quantity of RBs.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports enhancements for uplink control channels in accordance with one or more aspects of the present disclosure.

FIG. 2 shows an example of a wireless communications system that supports enhancements for uplink control channels in accordance with one or more aspects of the present disclosure.

FIG. 3 shows an example of a resource diagram that supports enhancements for uplink control channels in accordance with one or more aspects of the present disclosure.

FIG. 4 shows an example of a process flow that supports enhancements for uplink control channels in accordance with one or more aspects of the present disclosure.

FIGS. 5 and 6 show block diagrams of devices that support enhancements for uplink control channels in accordance with one or more aspects of the present disclosure.

FIG. 7 shows a block diagram of a communications manager that supports enhancements for uplink control channels in accordance with one or more aspects of the present disclosure.

FIG. 8 shows a diagram of a system including a device that supports enhancements for uplink control channels in accordance with one or more aspects of the present disclosure.

FIGS. 9 and 10 show block diagrams of devices that support enhancements for uplink control channels in accordance with one or more aspects of the present disclosure.

FIG. 11 shows a block diagram of a communications manager that supports enhancements for uplink control channels in accordance with one or more aspects of the present disclosure.

FIG. 12 shows a diagram of a system including a device that supports enhancements for uplink control channels in accordance with one or more aspects of the present disclosure.

FIGS. 13 through 16 show flowcharts illustrating methods that support enhancements for uplink control channels in accordance with one or more aspects of the present disclosure.

### DETAILED DESCRIPTION

Some wireless communication devices may communicate wireless signals in one or more frequency bands. In some relatively high bands (e.g., C-band, 3.5 gigahertz (GHz), frequency range 2 (FR2), frequency range 3 (FR3), or higher), uplink coverage may become a bottleneck to communication throughput. Physical uplink control channel (PUCCH) coverage issues may lead to data throughput degradation in the downlink. For instance, a lack of PUCCH coverage may result in a failure to communicate hybrid automatic repeat request (HARQ) indicators, which may cause a network to retransmit signals that were previously received successfully by a user equipment (UE). The retransmissions may consume downlink resources, which may reduce throughput. Accordingly, PUCCH coverage issues may make the use of some high bands or spectrum more challenging.

In some approaches, frequency division duplexing (FDD) and time-division duplexing (TDD) (“F+T”) carrier aggregation (CA) or TDD and TDD (“T+T”) CA may be utilized. For example, a component carrier (CC) for TDD may be located in the C-band. For the case of F+T, a PUCCH may be transmitted on the FDD primary cell (PCell) on a CC that is lower in frequency than the CC for TDD. Due to the better coverage of the PUCCH on the lower CC, TDD downlink signals may be communicated successfully for reduced received powers (e.g., lower reference signal received powers (RSRPs)). Accordingly, one way to expand the use of downlink in relatively higher bands may rely on a lower-band coverage layer to carry control information (e.g., uplink of an FDD band).

If relatively higher bands and lower bands are co-located, carrier aggregation may be utilized, where relatively lower bands may be utilized as PCells to carry uplink control signaling. In non-collocated deployments, anchoring on a relatively lower-band channel may be difficult to achieve. One reason for poor PUCCH coverage in relatively higher bands (e.g., massive multiple input or multiple output (mMIMO) bands) may be that some networks may not combine the PUCCH demodulation reference signal (DMRS) across receive antennas. Accordingly, PUCCH reception may not benefit from the full mMIMO receive combining gain. In some approaches, DMRS signals may not be combined due to implementation challenges or because PUCCH processing may be constrained in time for scheduling and combining across all antennas may reduce available time for processing. Accordingly, techniques for enhancing the coverage of a PUCCH within relatively higher band spectrum may be useful.

Some examples of the techniques described herein may provide a new sounding reference signal (SRS) for PUCCH. In some examples, the SRS for PUCCH may have one resource set (e.g., an SRS for codebook (CB) approaches) or may have multiple resource sets (e.g., an SRS for non-codebook (NCB) approaches). In a case of multiple resource sets, a network may use the SRS for selecting one or more antennas or ports or a combination thereof (e.g., for antenna-to-port virtualization). In some examples, a total bandwidth for the SRS with PUCCH may be limited to a quantity of resource blocks (RBs) supported across PUCCH formats. Additionally, or alternatively, the SRS for PUCCH may be located in one or more bands (e.g., band(s) at the edge(s) of a channel utilized for physical uplink shared channel (PUSCH) and PUCCH communication). The SRS for PUCCH may allow for antenna combining for the PUCCH, which may improve PUCCH reception performance. In some examples of utilizing an SRS for PUCCH, the SRS (e.g., a narrowband (NB) SRS) may be utilized to determine or provide a channel estimate with enhanced accuracy. The enhanced accuracy may be obtained even for UEs at a cell edge.

Aspects of the disclosure are initially described in the context of wireless communications systems. Aspects of the disclosure are also described in the context of a resource diagram and a process flow diagram. Aspects of the disclosure are further illustrated by and described with reference to apparatus diagrams, system diagrams, and flowcharts that relate to enhancements for uplink control channels.

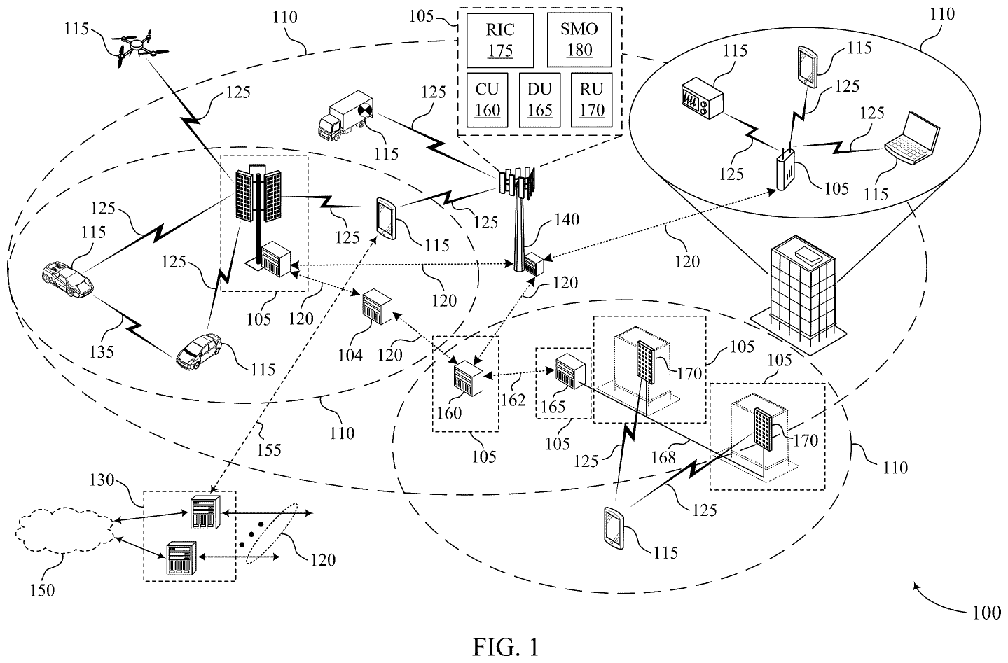

FIG. 1 shows an example of a wireless communications system 100 that supports enhancements for uplink control channels in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support enhancements for uplink control channels as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or RBs) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

Some wireless communication devices may communicate wireless signals in one or more frequency bands. In some relatively high bands (e.g., C-band, 3.5 GHz, FR2, FR3, or higher), uplink coverage may become a bottleneck to communication throughput. PUCCH coverage issues may lead to data throughput degradation in the downlink. For instance, a lack of PUCCH coverage may result in a failure to communicate HARQ indicators, which may cause a network to retransmit signals that were previously received successfully by a UE. The retransmissions may consume downlink resources, which may reduce throughput. Accordingly, PUCCH coverage issues may make the use of some high bands or spectrum more challenging.

In some approaches, FDD and TDD (“F+T”) CA or TDD and TDD (“T+T”) CA may be utilized. For example, a CC for TDD may be located in the C-band. For the case of F+T, a PUCCH may be transmitted on the FDD PCell on a CC that is lower in frequency than the CC for TDD. Due to the better coverage of the PUCCH on the lower CC, TDD downlink signals may be communicated successfully for reduced received powers (e.g., lower RSRPs). Accordingly, one way to expand the use of downlink in relatively higher bands may rely on a lower-band coverage layer to carry control information (e.g., uplink of an FDD band).

If relatively higher bands and lower bands are co-located, carrier aggregation may be utilized, where relatively lower bands may be utilized as PCells to carry uplink control signaling. In non-collocated deployments, anchoring on a relatively lower-band channel may be difficult to achieve. One reason for poor PUCCH coverage in relatively higher bands (e.g., mMIMO bands) may be that some networks may not combine the PUCCH DMRS across receive antennas. Accordingly, PUCCH reception may not benefit from the full mMIMO receive combining gain. In some approaches, DMRS signals may not be combined due to implementation challenges or because PUCCH processing may be constrained in time for scheduling and combining across all antennas may reduce available time for processing. Accordingly, techniques for enhancing the coverage of a PUCCH within relatively higher band spectrum may be useful.

Some examples of the techniques described herein may provide a new SRS for PUCCH. In some examples, the SRS for PUCCH may have one resource set (e.g., an SRS for CB approaches) or may have multiple resource sets (e.g., an SRS for NCB approaches). A UE 115 may transmit the SRS to a network entity 105. In a case of multiple resource sets, a network (e.g., network entity 105) may use the SRS for selecting one or more antennas or ports or a combination thereof (e.g., for antenna-to-port virtualization). In some examples, a total bandwidth for the SRS with PUCCH may be limited to a quantity of RBs supported across PUCCH formats. Additionally, or alternatively, the SRS for PUCCH may be located in one or more bands (e.g., band(s) at the edge(s) of a channel utilized for PUSCH and PUCCH communication). The SRS for PUCCH may allow for antenna combining for the PUCCH, which may improve PUCCH reception performance. In some examples of utilizing an SRS for PUCCH, the SRS (e.g., a narrowband (NB) SRS) may be utilized to determine or provide a channel estimate with enhanced accuracy. The enhanced accuracy may be obtained even for UEs at a cell edge. The UE 115-a power may be concentrated in one or more (e.g., a few) resource blocks.

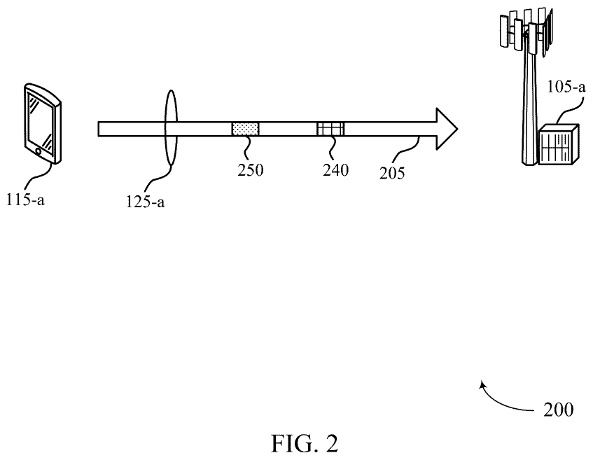

FIG. 2 shows an example of a wireless communications system 200 that supports enhancements for uplink control channels in accordance with one or more aspects of the present disclosure. The wireless communications system 200 may implement aspects of or may be implemented by aspects of the wireless communications system 100. For example, the wireless communications system 200 includes a UE 115-a, which may be an example of a UE 115 described with respect to FIG. 1. The wireless communications system 200 also includes a network entity 105-a, which may be an example of a network entity 105 as described with respect to FIG. 1.

The UE 115-a may communicate with the network entity 105-a using a communication link 125-a, which may be an example of a communication link 125 described with respect to FIG. 1. The communication link 125-a may include a bi-directional link that enables uplink or downlink network communications. For example, the UE 115-a may transmit one or more uplink transmissions 205, such as uplink control signals or uplink data signals, to the network entity 105-a using the communication link 125-a. In some examples, the network entity 105-a may transmit one or more downlink transmissions (not shown in FIG. 2), such as downlink control signals or downlink data signals, to the UE 115-a using the communication link 125-a.

The UE 115-a may transmit, or the network entity 105-a may obtain (e.g., receive), an SRS 240 associated with a PUCCH 250 via one or more resource sets. The SRS 240 may be a signal (e.g., electromagnetic signal, RF signal) with one or more established characteristics (e.g., signaling pattern, strength, amplitude, magnitude, frequency, timing, modulation, phase, or data, among other examples). For instance, the UE 115-a or the network entity 105-a may store information indicating one or more of the characteristics of the SRS 240, which may allow for comparison of one or more stored characteristics and one or more characteristics of the received SRS 240. The SRS 240 (e.g., the comparison) may enable channel estimation (e.g., channel attenuation, phase, frequency shift, or Doppler effects, among other examples). In some approaches, the SRS 240 associated with the PUCCH 250 may be more generally referred to as a reference signal for a PUCCH 250, a PUCCH SRS, an SRS for a control channel, or another term.

The SRS 240 associated with the PUCCH 250 may be communicated (e.g., output, transmitted, obtained, or received) via one or more resource sets. A resource set may be one or more resources, such as one or more frequency resources, time resources, spatial resources, code resources, or a combination thereof. In some examples, a resource set may include one or more resource elements (REs) (e.g., where an RE may include one or more subcarriers or OFDM symbols, among other examples), one or more RBs (e.g., where a resource block may include one or more REs, subcarriers, OFDM symbols, or slots, among other examples), one or more slots, one or more sub-slots, one or more frequency bands, one or more subcarriers, or a combination thereof, among other examples.

In some examples, the SRS 240 for the PUCCH 250 may be communicated via one resource set (e.g., with an SRS for CB approach) or may be communicated via multiple resource sets (e.g., with an SRS for an NCB approach). In some approaches with multiple resource sets, a network (e.g., the network entity 105-a) may select one or more antennas or ports or a combination of antennas or ports (e.g., for antenna-to-port virtualization).

In some examples, a bandwidth of the SRS 240 associated with the PUCCH 250 may be limited to a quantity of RBs supported for one or more PUCCH formats. For instance, a total bandwidth for the SRS 240 associated with the PUCCH 250 may be limited to a maximum quantity of RBs supported across PUCCH formats. Each PUCCH format may have a supported quantity of RBs (e.g., a quantity of RB(s) supported by the UE 115-a or network entity 105-a to communicate uplink control information (UCI) with a payload size or quantity of bits). The bandwidth of the SRS 240 may be limited to a quantity (e.g., maximum quantity) of RBs for one PUCCH format or across PUCCHs formats. For example, the bandwidth of the SRS 240 may be limited to 1, 2, 3, 4, or a different quantity of RBs.

The UE 115-a may transmit, or the network entity 105-a may obtain (e.g., receive), the PUCCH 250. In some aspects, the PUCCH 250 may be communicated via at least one RB within the quantity of RBs supported for the one or more PUCCH formats. For example, the PUCCH 250 may be communicated with one or more RBs in accordance with a PUCCH format. In some examples, the quantity of RBs utilized to communicate the PUCCH 250 may be less than or equal to the maximum quantity of RBs supported across PUCCH formats.

In some approaches, the network entity 105-a may output (e.g., transmit), or the UE 115-a may receive, information indicating a configuration of the SRS 240 associated with the PUCCH 250. For instance, the SRS 240 associated with the PUCCH 250 may be configured based on one or more signals or messages (e.g., RRC signaling, medium access control-control element (MAC-CE) signaling, layer 1 (L1) signaling, or downlink control information (DCI) signaling) from the network entity 105-a. The SRS 240 may be configured based on the quantity of RBs or one or more locations of one or more RBs for the PUCCH 250. For example, the SRS 240 for the PUCCH 250 may be configured according to resources to accommodate the PUCCH 250 transmission (e.g., one or more quantities of RBs or one or more locations of one or more RBs for the PUCCH 250). In some approaches, resources (e.g., the one or more quantities or RBs or the one or more locations of one or more RBs may be configured at one or more edges of a channel (e.g., two edges of the channel) or allocated band.

In some aspects, communicating (e.g., transmitting or receiving) the SRS 240 associated with the PUCCH 250 may include communicating the SRS 240 via at least one RB that overlaps in frequency with the at least one RB utilized to communicate the PUCCH 250. For instance, the SRS 240 and the PUCCH 250 may overlap in frequency (e.g., completely overlap, partially overlap, or utilize one or more of the same subcarriers). In some approaches, the SRS 240 and the PUCCH 250 may occupy one or more frequency resources (e.g., subcarriers) at one or more edges of a channel or allocated band. For example, the SRS 240 and the PUCCH 250 may be situated in frequency next to, adjacent to, or at one or more edges of a channel or band allocated for communications between the UE 115-a and the network entity 105-a. In some approaches, the SRS 240 or the PUCCH 250 may not occupy a frequency range (e.g., central frequency range) of the channel or band. For instance, the SRS 240 or the PUCCH 250 may not overlap in frequency with one or more frequency resources utilized for a PUSCH or another SRS (e.g., second SRS).

In some approaches, the SRS 240 may be independent from or may differ from one or more other reference signals. Examples of other reference signals may include another SRS (e.g., an SRS for a PUSCH, an SRS for a data channel, a second SRS) or a DMRS, among other examples. For instance, the SRS 240 may be independent of a second SRS associated with a PUSCH. In some examples, the SRS 240 may be configured with information independent from second information for configuring the second SRS. In some aspects, for other SRS use cases (e.g., CB or NCB-PUSCH), the bit width of one or more SRS resource indicator (SRI) fields may be determined based on a quantity of SRS sets and resources within the set. Utilizing an independent SRS 240 may enable the SRS 240 signaling and associated overhead independent from other usages (e.g., from that of the second SRS). For instance, the SRS 240 may be implemented as a new use case, and the second SRS may not be reused for the PUCCH in some approaches.

In some examples, precoding may be performed for the PUCCH 250 transmission, which may be associated with the SRS 240. For instance, the network entity 105-a may output (e.g., transmit), or the UE 115-a may receive, a transmitted precoding matrix indicator (TPMI) or a transmission configuration indicator (TCI) for the PUCCH 250. The TPMI or the TCI may be based on the SRS 240 associated with the PUCCH 250. For instance, with the SRS 240 utilized for the PUCCH 250, the network entity 105-a (e.g., gNB) may obtain channel information (e.g., a channel estimate or full channel information), which may be utilized to determine or assign (e.g., configure) one or more TPMIs or a TCI (e.g., in a case of FR2) for PUCCH 250 communication.

In some approaches, the network entity 105-a may output (e.g., transmit), or the UE 115-a may receive, a TPMI or a TCI for the PUCCH 250, where the TPMI or the TCI for the PUCCH 250 is communicated via DCI. A precoding matrix (e.g., indicated by the TPMI or the TCI) for the PUCCH 250 may be independent from a precoding matrix for a PUSCH or may be equal to a precoding matrix for the PUSCH. For instance, the UE 115-a may transmit the PUCCH 250 using a precoding matrix indicated by the TPMI or the TCI received via DCI, where the precoding matrix may be independent from (e.g., configured by the network entity 105-a independently from) a precoding matrix for a PUSCH or may be the same as (e.g., equal to) a precoding matrix for a PUSCH.

With the SRS 240 for the PUCCH 250, for example, the network (e.g., network entity 105-a) may indicate to the UE 115-a which precoder to select or utilize. In some aspects, a TPMI indication for (e.g., associated with) the PUCCH 250 may have (e.g., may be indicated via) a dedicated field in the DCI. In some approaches, transmit precoding matrices (TPMs) for PUCCH and PUSCH may be specified or configured separately, or the PUCCH 250 transmission may utilize one or more of the same set of N-layer matrices (e.g., 1-layer matrices) as are available for PUSCH transmission. For instance, a PUCCH 250 may be a single- or multi-layer (e.g., N-layer) transmission, where one or more PUSCH TPMIs that support up to one or more (e.g., N) layers may be utilized for the PUCCH.

In some examples, the network (e.g., network entity 105-a) may indicate to the UE 115-a explicitly whether to utilize a specific TPMI or to use one (e.g., a best performing or strongest TPMI) that was utilized for a previous PUSCH transmission. For instance, the network entity 105-a may transmit a signal or message explicitly indicating (e.g., instructing, commanding, requesting) the UE 115-a to utilize a TPMI or to utilize a TPMI associated with a PUSCH transmission.

In some approaches, the indication of TPMI for the PUCCH 250 may be implicit or less explicit. For example, a phase tracking reference signal (PTRS)-to-DMRS association field may indicate which DMRS port (e.g., a best performing DMRS port or a DMRS port with a strongest signal) is associated with a PTRS. The UE 115-a may utilize the same port for the PUCCH 250 transmission (e.g., the network entity 105-a may send an indication for the UE 115-a to utilize the same port for PUCCH 250 transmission). Utilizing the same port may be useful if a PUSCH was transmitted before the PUCCH 250, but with less than a threshold gap in time between the PUSCH and the PUCCH 250 (e.g., without a relatively large gap in time). The threshold gap in time may be expressed in slots, sub-slots, ms, microseconds (μs), subframes, or another unit. Examples of the threshold gap in time may be 143 μs, 0.5 ms, 1 ms, 3 ms, 10 ms, 1 second, 5 seconds, or another amount. In some examples, the UE 115-a may transmit, or the network entity 105-a may obtain (e.g., receive), previous to communication of the PUCCH 250, a PUSCH utilizing a port, where the PUCCH 250 may be transmitted utilizing the port that was utilized for transmission of the PUSCH.

In some aspects, the PUCCH 250 may be communicated (e.g., output, transmitted, obtained, or received) based on a precoding matrix that varies based on a frequency associated with a resource element (RE), an RB, or a precoding resource block group (PRG). In some examples, the TPMI for the PUCCH 250 may be frequency dependent, per RE, RB, or PRG. In some approaches, cyclic delay diversity (e.g., “large delay” CDD (LD-CDD), which may be half a symbol time shift across antennas) may be employed per RE. For instance, a half-symbol offset may be the same as precoding ports (e.g., DMRS ports) with [1, 1], [1, −1], [1, 1], [1, −1], and so on. Other shifts may be utilized in other examples. In some approaches, the shift may be indicated or communicated between the UE 115-a and the network entity 105-a (e.g., may be reported by the UE 115-a or indicated by the network). In some approaches, frequency division (FD) TPMI may not be limited to LD-CDD. For example, the network (e.g., network entity 105-a) or the UE 115-a may determine one or more precoders to utilize, or may communicate (e.g., output, transmit, obtain, or receive) an indication of the one or more precoders.

In some approaches, the UE 115-a may perform a diversity-based PUCCH 250 transmission. One or more techniques for diversity-based transmissions (e.g., “small” CDD (S-CDD), “large” CDD (L-CDD) or space frequency block coding (SFBC)) may be utilized for PUCCH 250 transmission (e.g., in accordance with one or more PUCCH formats for which the techniques may be utilized). In some cases, CDD may be applied in a non-transparent mode (where an indication of the CDD may be communicated between the UE 115-a and the network entity 105-a, for instance). A transparent CDD may make channel estimation challenging on the receiver side (for PUCCHs with a relatively small quantity of RBs, for instance). For example, a time-delay for the CDD may result in an abrupt phase change in frequency (e.g., abrupt due to the relatively few REs available).

In some examples, the UE 115-a or the network entity 105-a may communicate an indication of a time delay across antennas for the PUCCH 250. The time delay may be based on a PUCCH format, a quantity of RBs, or a payload of the PUCCH 250. The PUCCH 250 may be transmitted based on the time delay. For instance, the time delay applied across antennas for the PUCCH 250 transmission may be indicated to the receiver side (e.g., to the network entity 105-a). Applying this additional delay may help the receiver (e.g., the network entity 105-a) to estimate a channel power delay profile (PDP) more accurately. In some approaches, the value of the time delay may be selected by the UE 115-a and indicated (e.g., reported or signaled) to the network (e.g., network entity 105-a). For example, the indication (e.g., reported value) may be dependent on the PUCCH format, quantity of RBs, or payload. In some aspects, the indication may be communicated via an RRC message, MAC-CE, L1 signaling, or UCI signaling.

In some approaches, the UE 115-a may update the value of the time delay, but the indicated (e.g., reported) value may be applicable to a duration of time. For example, a prohibit timer may be utilized to control (e.g., postpone) reporting a new or updated value. For instance, the prohibit timer may prohibit reporting a new or updated value of the time delay while the prohibit timer is running (e.g., up to a threshold time, 0.5 ms, 1 ms, 3 ms, 10 ms, 1 second, 5 seconds, or another amount).

In some aspects, the indication (e.g., report) of the time delay may be based on a request or indication from the network (e.g., network entity 105-a). For example, the network entity 105-a may output (e.g., transmit), or the UE 115-a may receive, a request for the indication of the time delay across the antennas for the PUCCH 250, where communicating the indication of the time delay may be based on the request.

In some approaches, the network (e.g., network entity 105-a) may select a time delay and indicate the time delay to the UE 115-a. The UE 115-a may utilize the indicated time delay to transmit the PUCCH 250. The indication may be the same or different for different PUCCH formats, PUCCH resources (e.g., based on a quantity of RBs), or UCI payload. For approaches where the network (e.g., network entity 105-a) selects the time delay, it may be useful for the network to have an indication of how many antennas (e.g., physical antennas) are virtualized in a port. In some aspects, the UE 115-a may communicate an indication of an association between a quantity of antennas and a port to the network entity 105-a.

In some approaches, one or more diversity-based schemes may be utilized to address the channel estimation issues (for a narrowband (NB) PUCCH, for example). A PUCCH 250 diversity-based scheme may be dependent on a quantity of RBs used for the PUCCH 250 communication. For instance, the PUCCH 250 may be communicated (e.g., transmitted) with a transmission scheme (e.g., diversity scheme) that is based on a quantity of RBs utilized for transmission of the PUCCH 250. In some examples, if a quantity of RBs is less than a threshold (e.g., X), SFBC may be used. Otherwise, CDD may be used. The value of the threshold (e.g., X) may be established (e.g., specified) or may be indicated from the network entity 105-a to the UE 115-a. For example, the value of the threshold may be indicated as part of a PUCCH resource configuration (which configuration may include a TxScheme field indicating the value of the threshold, for instance). For PUCCHs with a quantity of RBs greater than the threshold (e.g., X), CDD may be utilized, which may be transparent or non-transparent. The non-transparent approach may help to improve performance. Whether to report the time-delay or not (e.g., applying a non-transparent mode or a transparent mode) may be determined by the network (e.g., network entity 105-a).

In some examples, the UE 115-a or the network entity 105-a may communicate an indication of a time delay across antennas for the SRS 240 associated with the PUCCH 250, where the SRS 240 and the PUCCH 250 are transmitted based at least in part on the time delay. If the SRS 240 for the PUCCH 250 is configured, for instance, the CDD time delay may not be reported by the UE 115-a for the PUCCH 250. Instead, a report or indication of the time delay from the network (e.g., network entity 105-a) may be utilized for the SRS 240. With this information (e.g., the time delay), the network (e.g., network entity 105-a) may obtain or determine information about the channel (e.g., a channel estimate with increased accuracy). The UE 115-a may apply the same time delay for the PUCCH 250 transmission (as for the SRS 240, for instance) when CDD is utilized. In some approaches, the UE 115-a may report the CDD time delay for the PUCCH 250.

In some examples, the UE 115-a may transmit, or the network entity 105-a may obtain, a power headroom report (PHR) associated with the PUCCH 250. The PHR may be independent from a PHR associated with a PUSCH. In some examples of the techniques described herein, a PHR for the PUCCH 250 may be supported. The PHR for the PUCCH 250 may provide improved information to the network (e.g., network entity 105-a) for setting uplink power or selecting one or more formats (e.g., PUCCH format(s)). In some approaches, the PHR for the PUCCH 250 may be communicated (e.g., reported) via a MAC-CE for one or more (e.g., any) serving cell(s) that may have a PUCCH (e.g., PUCCH 250) communication. In some examples, the PHR may be associated with (e.g., utilized for or provided to) a PCell or a primary secondary cell group (SCG) cell (PSCell), may be utilized in the context of frequency selective interference (FSI) with the PUCCH 250 for subband switching, or for one or more cells or subbands that have a PUCCH configuration.

In some approaches, the PHR may be actual (e.g., may be based on the actual PUCCH 250 that is transmitted) or may be virtual (e.g., may be based on one or more apriori-indicated parameters). For example, for virtual reports, the network (e.g., network entity 105-a) may configure the UE 115-a (e.g., send signaling to configure the UE 115-a) to report a PHR for a PUCCH with one or more (e.g., different) assumptions, such as different formats, a different quantities of symbols, different quantities of RBs, or different payloads. The PHR for multiple configurations may be included in a MAC-CE for a serving cell (e.g., corresponding serving cell).

In some aspects, the network entity 105-a may output (e.g., transmit), or the UE 115-a may receive, a synchronization signal block (SSB). The UE 115-a may transmit, or the network entity 105-a may obtain (e.g., receive), an indication of one or more recommended resources for transmitting the PUCCH 250. The indication may indicate a recommended quantity of repetitions for the PUCCH 250, one or more recommended PUCCH formats, a recommended quantity of symbols, or a recommended quantity of RBs. Based on an SSB measurement, for example, the UE 115-a may request or recommend in a message 3 (e.g., msg3 in a case of a 4-step random access channel (RACH) procedure) or in a message A (e.g., msgA-PUSCH in a case of a 2-step RACH procedure), a PUCCH resource for utilization in a response (e.g., in a message 4 (msg4) or message B (msgB)). For instance, the UE 115-a may request or recommend a quantity of repetitions for the PUCCH 250 or different PUCCH formats or resources (e.g., a quantity of symbols or a quantity of RBs). Providing the recommendations may enhance the PUCCH 250 (e.g., PUCCH coverage) for an initial access procedure.

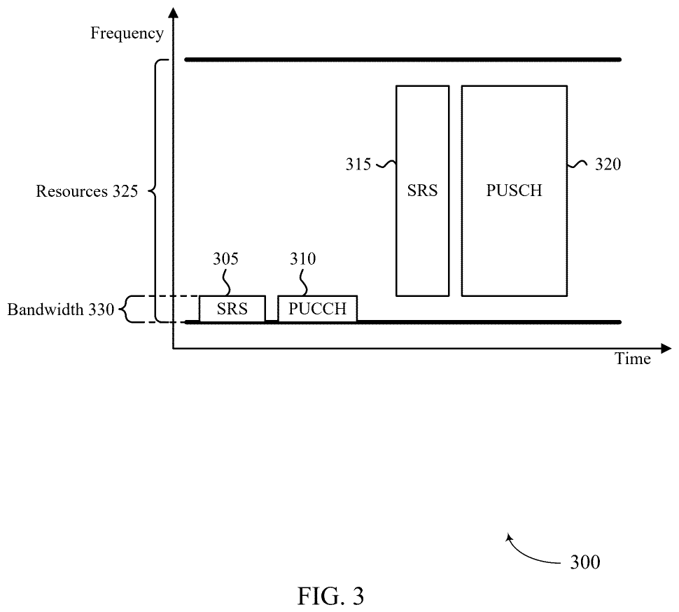

FIG. 3 shows an example of a resource diagram 300 that supports enhancements for uplink control channels in accordance with one or more aspects of the present disclosure. Some examples of the techniques described herein may be performed in accordance with the example provided in FIG. 3. As illustrated in FIG. 3, time and frequency resources 325 may be utilized or allocated for a communication link. One or more of the techniques or communications described with reference to FIG. 3 may be performed as described with reference to FIG. 2.

A first SRS 305 may be associated with a PUCCH 310. For instance, the first SRS 305 may be utilized to sound frequency resources for a PUCCH 310. As illustrated in FIG. 3, a bandwidth 330 of the first SRS 305 may be limited to a quantity of RBs corresponding to a PUCCH 310 (e.g., a PUCCH format). The first SRS 305 may overlap in the frequency domain with the PUCCH 310. The SRS 305 or PUCCH 310 may be located at an edge of the resources 325 (e.g., channel) provided for communications between a UE and a network entity. In some examples, another SRS for a PUCCH (not shown in FIG. 3) may be located at the other edge of the resources 325.

As illustrated in FIG. 3, some of the resources 325 (e.g., between the edges of the resources 325, a subset of the resources 325 located at a frequency away from the edge(s) of the resources 325, or some centrally-located resources) may be utilized to communicate a PUSCH 320. A second SRS 315 may be associated with (e.g., utilized for) the PUSCH 320. The second SRS 315 may not be limited to a quantity of RBs corresponding to the PUCCH 310 (e.g., PUCCH format). In some examples, the SRS 315 may occupy more RBs or a larger frequency range than the first SRS 305.

In some cases, the first SRS 305 for the PUCCH 310 and the second SRS 315 for the PUSCH may be configured independently (e.g., utilizing separate fields or with separate values). Utilizing the first SRS 305 may enable a UE to determine a channel estimate for the PUCCH 310, which may enable the PUCCH 310 to be communicated with antenna diversity, antenna combining, with a precoding matrix, or with a PHR as described with reference to FIG. 2.

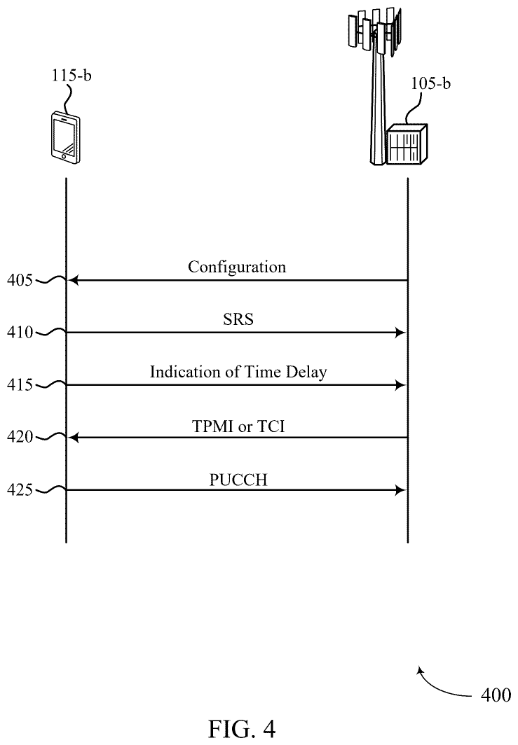

FIG. 4 shows an example of a process flow 400 that supports enhancements for uplink control channels in accordance with one or more aspects of the present disclosure. A wireless communication system may include a UE 115-b and a network entity 105-b. The UE 115-b may be an example of the UEs 115 or the UE 115-a, or the network entity 105-b may be an example of the network entities 105 or the network entity 105-a, as described herein.

In the following description of the process flow 400, the communications between the network entity 105-b and the UE 115-b may be transmitted in a different order than the example order shown, or the operations performed by the network entity 105-b and the UE 115-b may be performed in different orders or at different times. Some operations may be omitted from the process flow 400, or other operations may be added to the process flow 400. Although some operations or signaling may be shown to occur at different times for discussion purposes, these operations may actually occur at the same time or in overlapping time periods in some examples.

At 405, the network entity 105-b may output (e.g., transmit), or the UE 115-b may receive, information indicating a configuration of a SRS associated with a PUCCH. For example, the UE 115-b may receive the information indicating the configuration of the SRS as described with reference to FIG. 2.

At 410, the UE 115-b may transmit, or the network entity 105-b may obtain (e.g., receive) the SRS associated with a PUCCH. For example, the UE 115-b may transmit the SRS associated with the PUCCH as described with reference to FIG. 2 or FIG. 3.

At 415, the UE 115-b may transmit, or the network entity 105-b may obtain (e.g., receive) an indication of a time delay. For example, the UE 115-b may transmit the indication of the time delay across antennas for the PUCCH as described with reference to FIG. 2. In some examples, the network entity 105-b may utilize the SRS or indication of the time delay to estimate a channel. The channel estimate may be utilized to determine a precoding matrix, a TPMI, or a TCI, for example.

At 420, the network entity 105-b may output (e.g., transmit), or the UE 115-b may receive a TPMI or a TCI for the PUCCH. For example, the UE 115-b may receive the TPMI or TCI as described with reference to FIG. 2.

At 425, the UE 115-b may transmit, or the network entity 105-b may obtain (e.g., receive) a PUCCH. For example, the UE 115-b may transmit the PUCCH utilizing a precoding matrix (e.g., the TPMI or TCI) as described with reference to FIG. 2. In some examples, the network entity 105-b may utilize the PUCCH to perform one or more control operations (e.g., based on control information or instructions included in the PUCCH). For instance, the PUCCH may include HARQ, which the network entity 105-b may utilize to determine whether to perform one or more retransmissions. Additionally, or alternatively, the network entity 105-b may perform link adaptation or power control based on the information provided by the PUCCH.

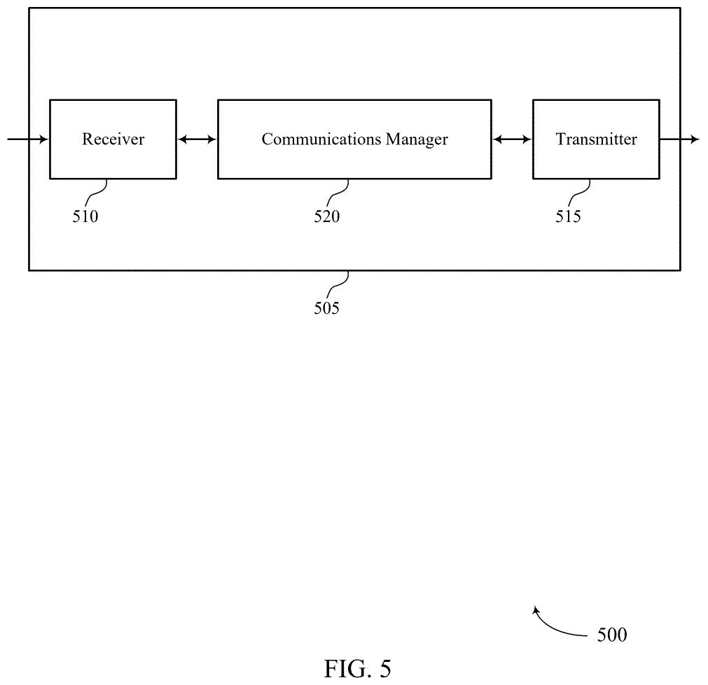

FIG. 5 shows a block diagram 500 of a device 505 that supports enhancements for uplink control channels in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to enhancements for uplink control channels). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to enhancements for uplink control channels). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of enhancements for uplink control channels as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for transmitting, to a network entity, an SRS associated with a PUCCH via one or more resource sets. In some examples, a bandwidth of the SRS associated with the PUCCH may be limited to a quantity of RBs supported for one or more PUCCH formats. The communications manager 520 is capable of, configured to, or operable to support a means for transmitting, to the network entity, the PUCCH via at least one RB within the quantity of RBs supported for the one or more PUCCH formats.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for reduced processing, reduced power consumption, or more efficient utilization of communication resources.

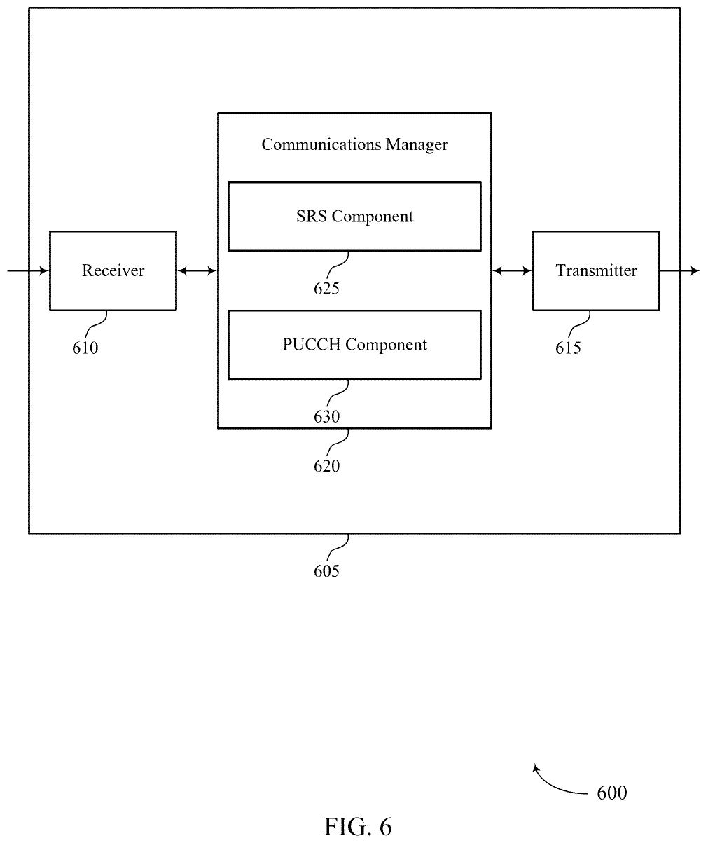

FIG. 6 shows a block diagram 600 of a device 605 that supports enhancements for uplink control channels in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to enhancements for uplink control channels). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to enhancements for uplink control channels). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of enhancements for uplink control channels as described herein. For example, the communications manager 620 may include an SRS component 625 a PUCCH component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The SRS component 625 is capable of, configured to, or operable to support a means for transmitting, to a network entity, an SRS associated with a PUCCH via one or more resource sets. In some examples, a bandwidth of the SRS associated with the PUCCH may be limited to a quantity of RBs supported for one or more PUCCH formats. The PUCCH component 630 is capable of, configured to, or operable to support a means for transmitting, to the network entity, the PUCCH via at least one RB within the quantity of RBs supported for the one or more PUCCH formats.

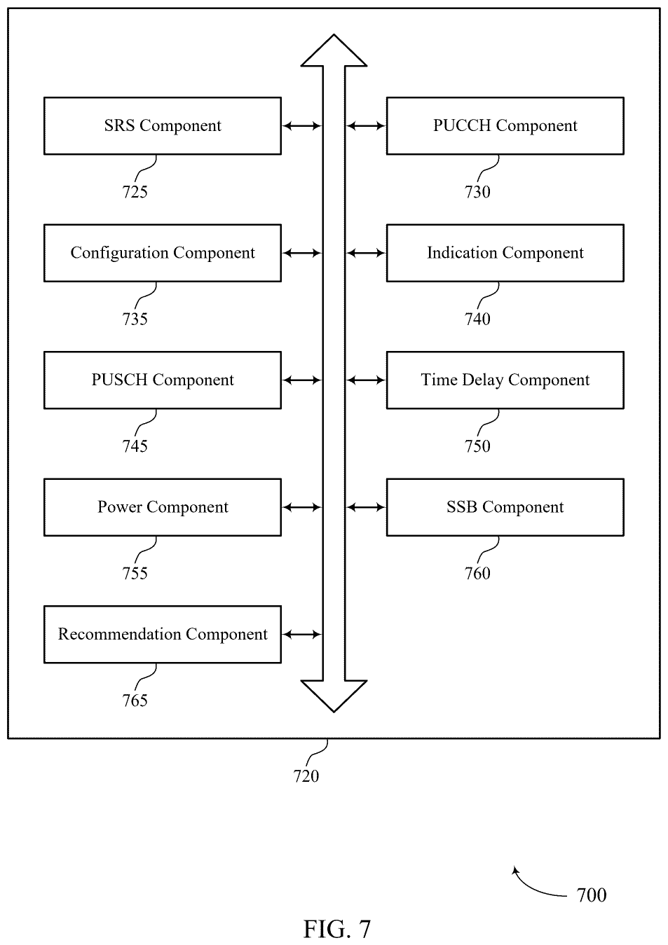

FIG. 7 shows a block diagram 700 of a communications manager 720 that supports enhancements for uplink control channels in accordance with one or more aspects of the present disclosure. The communications manager 720 may be an example of aspects of a communications manager 520, a communications manager 620, or both, as described herein. The communications manager 720, or various components thereof, may be an example of means for performing various aspects of enhancements for uplink control channels as described herein. For example, the communications manager 720 may include an SRS component 725, a PUCCH component 730, a configuration component 735, an indication component 740, a PUSCH component 745, a time delay component 750, a power component 755, an SSB component 760, a recommendation component 765, or any combination thereof. Each of these components, or components or subcomponents thereof (e.g., one or more processors, one or more memories), may communicate, directly or indirectly, with one another (e.g., via one or more buses).

The SRS component 725 is capable of, configured to, or operable to support a means for transmitting, to a network entity, an SRS associated with a PUCCH via one or more resource sets. In some examples, a bandwidth of the SRS associated with the PUCCH may be limited to a quantity of RBs supported for one or more PUCCH formats. The PUCCH component 730 is capable of, configured to, or operable to support a means for transmitting, to the network entity, the PUCCH via at least one RB within the quantity of RBs supported for the one or more PUCCH formats.

In some examples, to support transmitting the SRS associated with the PUCCH, the SRS component 725 is capable of, configured to, or operable to support a means for transmitting the SRS via at least one RB that overlaps in frequency with the at least one RB utilized to communicate the PUCCH.

In some examples, the configuration component 735 is capable of, configured to, or operable to support a means for receiving information indicating a configuration of the SRS associated with the PUCCH, where the SRS is configured based on the quantity of RBs or one or more locations of one or more RBs for the PUCCH.

In some examples, the SRS is independent of a second SRS associated with a PUSCH.

In some examples, the indication component 740 is capable of, configured to, or operable to support a means for receiving a TPMI or a TCI for the PUCCH, where the TPMI or TCI is based on the SRS associated with the PUCCH.

In some examples, the indication component 740 is capable of, configured to, or operable to support a means for receiving a TPMI or a TCI for the PUCCH, where the TPMI or the TCI for the PUCCH is received via DCI, and where a precoding matrix for the PUCCH is independent from a precoding matrix for a PUSCH or is equal to a precoding matrix for the PUSCH.

In some examples, the PUSCH component 745 is capable of, configured to, or operable to support a means for transmitting, previous to transmitting the PUCCH, a PUSCH utilizing a port, where the PUCCH is transmitted utilizing the port that was utilized for transmission of the PUSCH.

In some examples, to support transmitting the PUCCH, the PUCCH component 730 is capable of, configured to, or operable to support a means for transmitting the PUCCH based on a precoding matrix that varies based on a frequency associated with a RE, an RB, or a PRG.

In some examples, the time delay component 750 is capable of, configured to, or operable to support a means for communicating an indication of a time delay across antennas for the PUCCH, where the time delay is based on a PUCCH format, the quantity of RBs, or a payload of the PUCCH, and where the PUCCH is transmitted based on the time delay.

In some examples, the time delay component 750 is capable of, configured to, or operable to support a means for receiving a request for the indication of the time delay across the antennas for the PUCCH, where communicating the indication of the time delay is based on the request.

In some examples, to support transmitting the PUCCH, the PUCCH component 730 is capable of, configured to, or operable to support a means for transmitting the PUCCH with a transmission scheme (e.g., diversity scheme) that is based on a quantity of RBs utilized for transmission of the PUCCH.

In some examples, the time delay component 750 is capable of, configured to, or operable to support a means for communicating an indication of a time delay across antennas for the SRS associated with the PUCCH, where the SRS and the PUCCH are transmitted based on the time delay.

In some examples, the power component 755 is capable of, configured to, or operable to support a means for transmitting a PHR associated with the PUCCH, where the PHR is independent from a PHR associated with a PUSCH.

In some examples, the SSB component 760 is capable of, configured to, or operable to support a means for receiving a SSB. In some examples, the recommendation component 765 is capable of, configured to, or operable to support a means for transmitting, based on receiving the SSB, an indication of one or more recommended resources for transmitting the PUCCH, where the indication indicates a recommended quantity of repetitions for the PUCCH, one or more recommended PUCCH formats, a recommended quantity of symbols, or a recommended quantity of RBs.

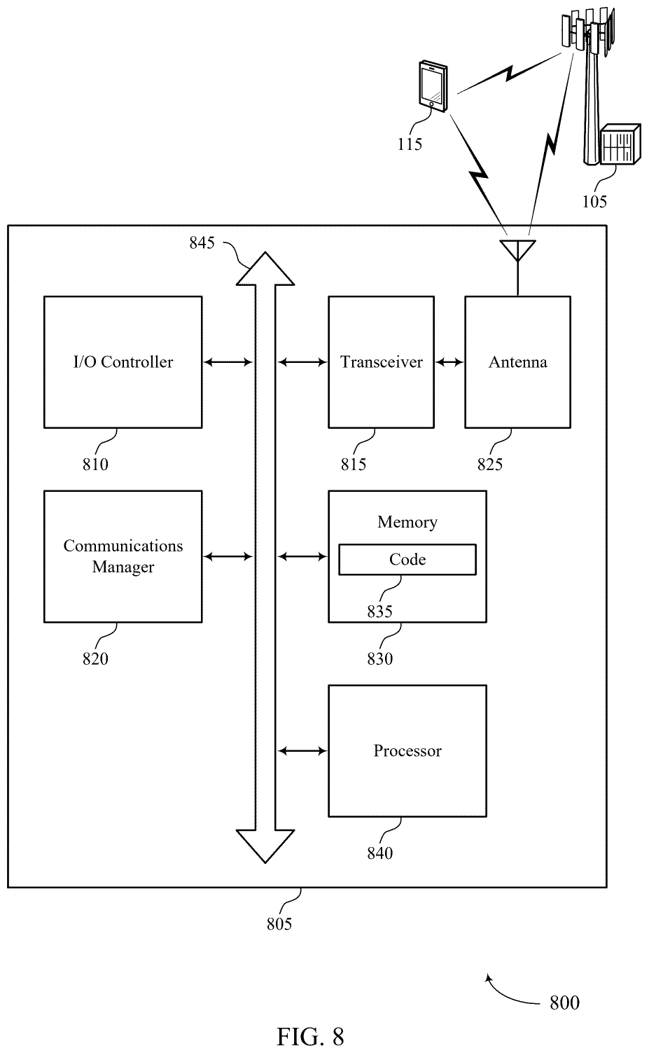

FIG. 8 shows a diagram of a system 800 including a device 805 that supports enhancements for uplink control channels in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting enhancements for uplink control channels). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

For example, the communications manager 820 is capable of, configured to, or operable to support a means for transmitting, to a network entity, an SRS associated with a PUCCH via one or more resource sets. In some examples, a bandwidth of the SRS associated with the PUCCH may be limited to a quantity of RBs supported for one or more PUCCH formats. The communications manager 820 is capable of, configured to, or operable to support a means for transmitting, to the network entity, the PUCCH via at least one RB within the quantity of RBs supported for the one or more PUCCH formats.

By including or configuring the communications manager 820 in accordance with examples as described herein, the device 805 may support techniques for improved communication reliability, reduced latency, reduced power consumption, more efficient utilization of communication resources, improved coordination between devices, longer battery life, or improved utilization of processing capability.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of enhancements for uplink control channels as described herein, or the at least one processor 840 and the at least one memory 830 may be otherwise configured to, individually or collectively, perform or support such operations.

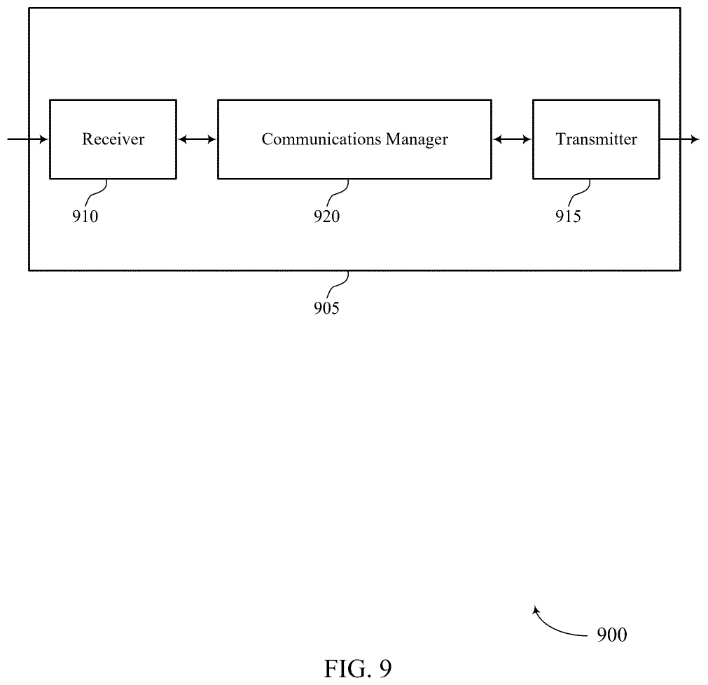

FIG. 9 shows a block diagram 900 of a device 905 that supports enhancements for uplink control channels in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques.

Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of enhancements for uplink control channels as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for obtaining, from a UE, an SRS associated with a PUCCH via one or more resource sets. In some examples, a bandwidth of the SRS associated with the PUCCH may be limited to a quantity of RBs supported for one or more PUCCH formats. The communications manager 920 is capable of, configured to, or operable to support a means for obtaining, from the UE, the PUCCH via at least one RB within the quantity of RBs supported for the one or more PUCCH formats.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for reduced processing, reduced power consumption, or more efficient utilization of communication resources.

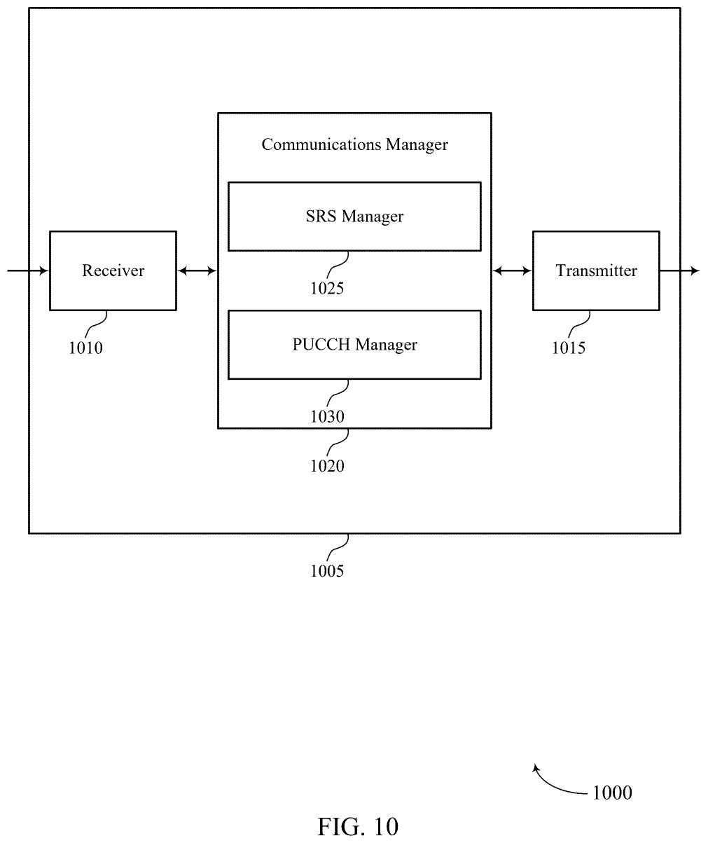

FIG. 10 shows a block diagram 1000 of a device 1005 that supports enhancements for uplink control channels in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of enhancements for uplink control channels as described herein. For example, the communications manager 1020 may include an SRS manager 1025 a PUCCH manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The SRS manager 1025 is capable of, configured to, or operable to support a means for obtaining, from a UE, an SRS associated with a PUCCH via one or more resource sets. In some examples, a bandwidth of the SRS associated with the PUCCH may be limited to a quantity of RBs supported for one or more PUCCH formats. The PUCCH manager 1030 is capable of, configured to, or operable to support a means for obtaining, from the UE, the PUCCH via at least one RB within the quantity of RBs supported for the one or more PUCCH formats.

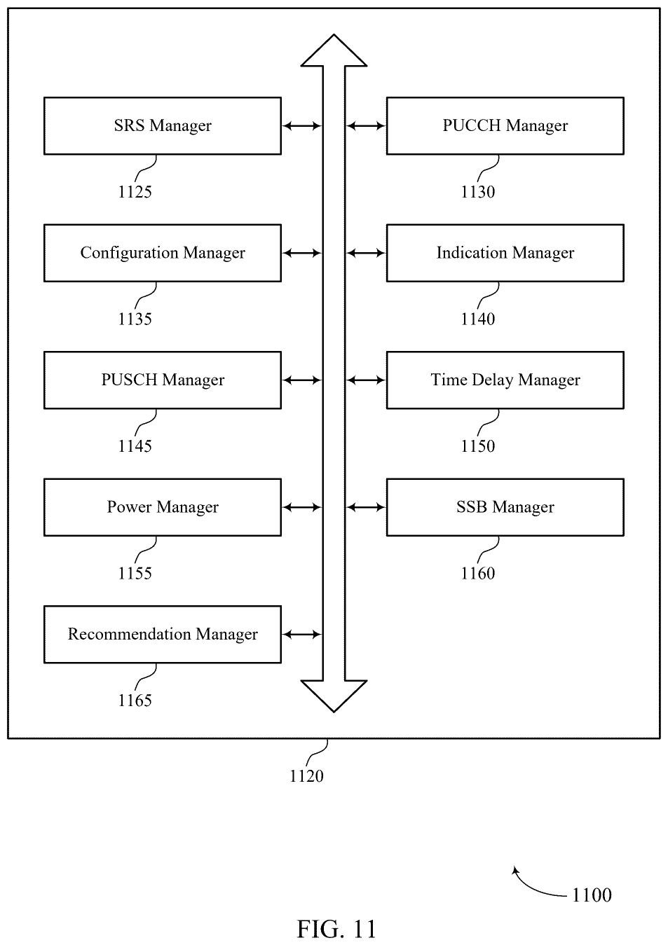

FIG. 11 shows a block diagram 1100 of a communications manager 1120 that supports enhancements for uplink control channels in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of enhancements for uplink control channels as described herein. For example, the communications manager 1120 may include an SRS manager 1125, a PUCCH manager 1130, a configuration manager 1135, an indication manager 1140, a PUSCH manager 1145, a time delay manager 1150, a power manager 1155, an SSB manager 1160, a recommendation manager 1165, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The SRS manager 1125 is capable of, configured to, or operable to support a means for obtaining, from a UE, an SRS associated with a PUCCH via one or more resource sets. In some examples, a bandwidth of the SRS associated with the PUCCH may be limited to a quantity of RBs supported for one or more PUCCH formats. The PUCCH manager 1130 is capable of, configured to, or operable to support a means for obtaining, from the UE, the PUCCH via at least one RB within the quantity of RBs supported for the one or more PUCCH formats.

In some examples, to support obtaining the SRS associated with the PUCCH, the SRS manager 1125 is capable of, configured to, or operable to support a means for obtaining the SRS via at least one RB that overlaps in frequency with the at least one RB utilized to communicate the PUCCH.

In some examples, the configuration manager 1135 is capable of, configured to, or operable to support a means for outputting information indicating a configuration of the SRS associated with the PUCCH, where the SRS is configured based on the quantity of RBs or one or more locations of one or more RBs for the PUCCH.

In some examples, the SRS is independent of a second SRS associated with a PUSCH.

In some examples, the indication manager 1140 is capable of, configured to, or operable to support a means for outputting a TPMI or a TCI for the PUCCH, where the TPMI or TCI is based on the SRS associated with the PUCCH.

In some examples, the indication manager 1140 is capable of, configured to, or operable to support a means for outputting a TPMI or a TCI for the PUCCH, where the TPMI or the TCI for the PUCCH is received via DCI, and where a precoding matrix for the PUCCH is independent from a precoding matrix for a PUSCH or is equal to a precoding matrix for the PUSCH.

In some examples, the PUSCH manager 1145 is capable of, configured to, or operable to support a means for obtaining, previous to obtaining the PUCCH, a PUSCH from a port, where the PUCCH is received from the port that was utilized for the PUSCH.

In some examples, to support obtaining the PUCCH, the PUCCH manager 1130 is capable of, configured to, or operable to support a means for obtaining the PUCCH based on a precoding matrix that varies based on a frequency associated with a RE, an RB, or a PRG.

In some examples, the time delay manager 1150 is capable of, configured to, or operable to support a means for communicating an indication of a time delay across antennas for the PUCCH, where the time delay is based on a PUCCH format, the quantity of RBs, or a payload of the PUCCH, and where the PUCCH is transmitted based on the time delay.

In some examples, the time delay manager 1150 is capable of, configured to, or operable to support a means for outputting a request for the indication of the time delay across the antennas for the PUCCH, where communicating the indication of the time delay is based on the request.

In some examples, to support obtaining the PUCCH, the PUCCH manager 1130 is capable of, configured to, or operable to support a means for obtaining the PUCCH with a transmission scheme (e.g., diversity scheme) that is based on a quantity of RBs utilized for transmission of the PUCCH.

In some examples, the time delay manager 1150 is capable of, configured to, or operable to support a means for communicating an indication of a time delay across antennas for the SRS associated with the PUCCH, where the SRS and the PUCCH are transmitted based on the time delay.

In some examples, the power manager 1155 is capable of, configured to, or operable to support a means for obtaining a PHR associated with the PUCCH, where the PHR is independent from a PHR associated with a PUSCH.

In some examples, the SSB manager 1160 is capable of, configured to, or operable to support a means for outputting a SSB. In some examples, the recommendation manager 1165 is capable of, configured to, or operable to support a means for obtaining, based on outputting the SSB, an indication of one or more recommended resources for obtaining the PUCCH, where the indication indicates a recommended quantity of repetitions for the PUCCH, one or more recommended PUCCH formats, a recommended quantity of symbols, or a recommended quantity of RBs.

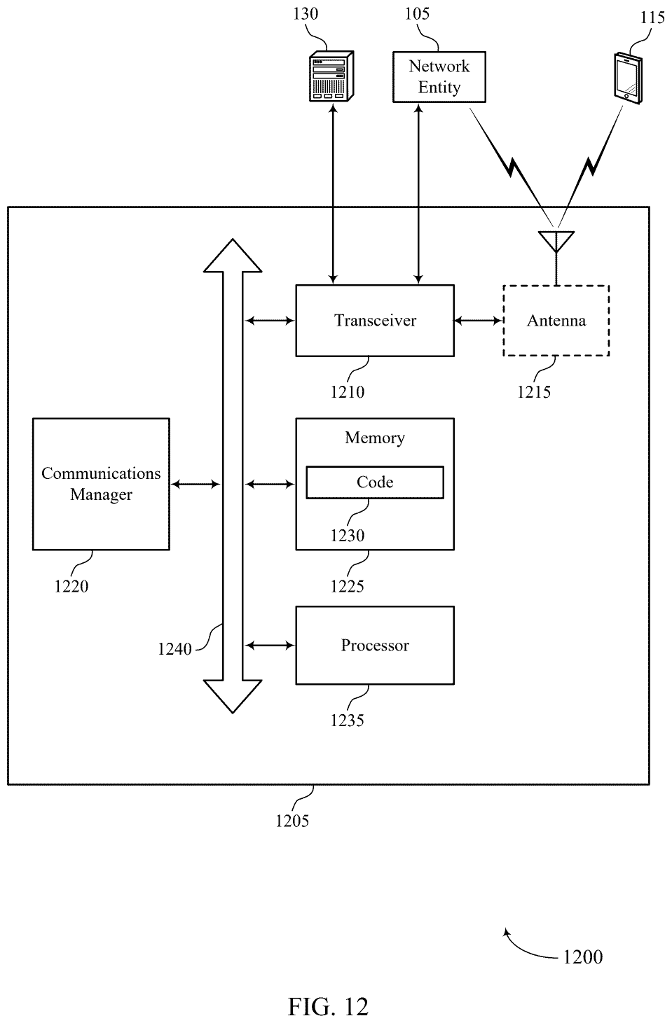

FIG. 12 shows a diagram of a system 1200 including a device 1205 that supports enhancements for uplink control channels in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting enhancements for uplink control channels). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

For example, the communications manager 1220 is capable of, configured to, or operable to support a means for obtaining, from a UE, an SRS associated with a PUCCH via one or more resource sets. In some examples, a bandwidth of the SRS associated with the PUCCH may be limited to a quantity of RBs supported for one or more PUCCH formats. The communications manager 1220 is capable of, configured to, or operable to support a means for obtaining, from the UE, the PUCCH via at least one RB within the quantity of RBs supported for the one or more PUCCH formats.

By including or configuring the communications manager 1220 in accordance with examples as described herein, the device 1205 may support techniques for improved communication reliability, reduced latency, reduced power consumption, more efficient utilization of communication resources, improved coordination between devices, longer battery life, or improved utilization of processing capability.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of enhancements for uplink control channels as described herein, or the at least one processor 1235 and the at least one memory 1225 may be otherwise configured to, individually or collectively, perform or support such operations.

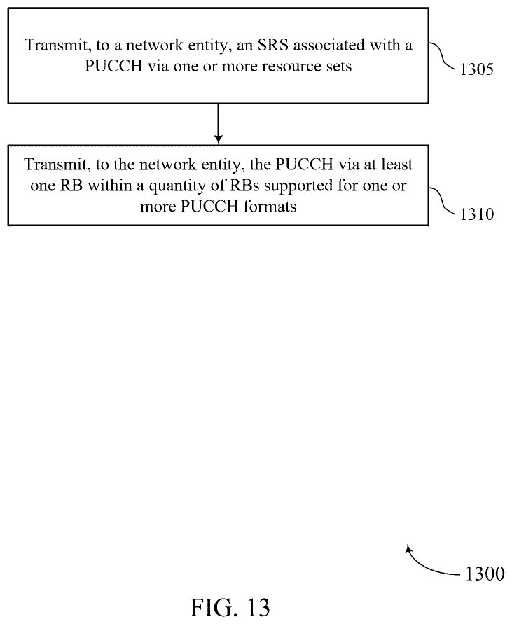

FIG. 13 shows a flowchart illustrating a method 1300 that supports enhancements for uplink control channels in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include transmitting, to a network entity, an SRS associated with a PUCCH via one or more resource sets. In some examples, a bandwidth of the SRS associated with the PUCCH may be limited to a quantity of RBs supported for one or more PUCCH formats. The operations of 1305 may be performed in accordance with examples as disclosed herein. In some examples, aspects of the operations of 1305 may be performed by an SRS component 725 as described with reference to FIG. 7.

At 1310, the method may include transmitting, to the network entity, the PUCCH via at least one RB within the quantity of RBs supported for the one or more PUCCH formats. The operations of 1310 may be performed in accordance with examples as disclosed herein. In some examples, aspects of the operations of 1310 may be performed by a PUCCH component 730 as described with reference to FIG. 7.

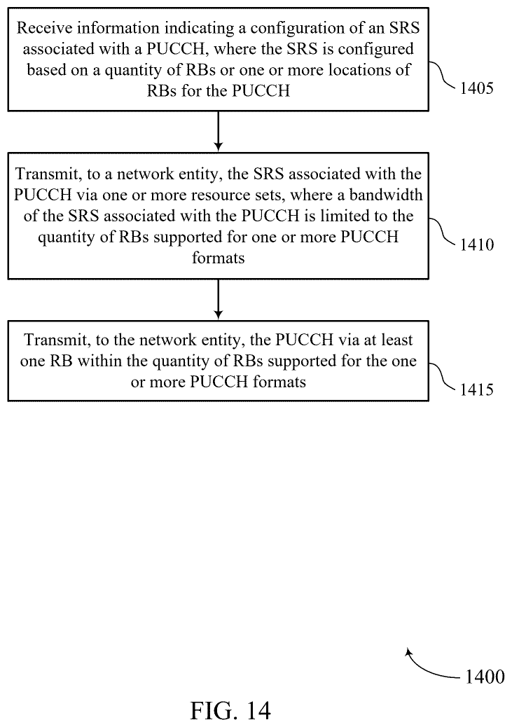

FIG. 14 shows a flowchart illustrating a method 1400 that supports enhancements for uplink control channels in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving information indicating a configuration of an SRS associated with a PUCCH, where the SRS is configured based on a quantity of RBs or one or more locations of one or more RBs for the PUCCH. The operations of 1405 may be performed in accordance with examples as disclosed herein. In some examples, aspects of the operations of 1405 may be performed by a configuration component 735 as described with reference to FIG. 7.

At 1410, the method may include transmitting, to a network entity, the SRS associated with the PUCCH via one or more resource sets. In some examples, a bandwidth of the SRS associated with the PUCCH may be limited to the quantity of RBs supported for one or more PUCCH formats. The operations of 1410 may be performed in accordance with examples as disclosed herein. In some examples, aspects of the operations of 1410 may be performed by an SRS component 725 as described with reference to FIG. 7.

At 1415, the method may include transmitting, to the network entity, the PUCCH via at least one RB within the quantity of RBs supported for the one or more PUCCH formats. The operations of 1415 may be performed in accordance with examples as disclosed herein. In some examples, aspects of the operations of 1415 may be performed by a PUCCH component 730 as described with reference to FIG. 7.

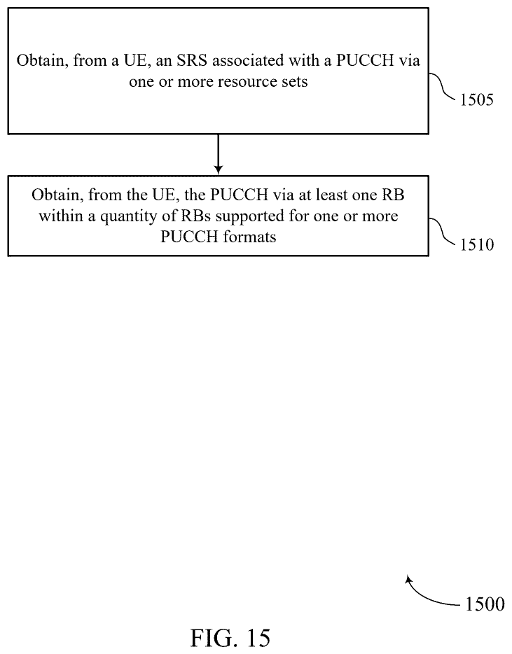

FIG. 15 shows a flowchart illustrating a method 1500 that supports enhancements for uplink control channels in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include obtaining, from a UE, an SRS associated with a PUCCH via one or more resource sets. In some examples, a bandwidth of the SRS associated with the PUCCH may be limited to a quantity of RBs supported for one or more PUCCH formats. The operations of 1505 may be performed in accordance with examples as disclosed herein. In some examples, aspects of the operations of 1505 may be performed by an SRS manager 1125 as described with reference to FIG. 11.

At 1510, the method may include obtaining, from the UE, the PUCCH via at least one RB within the quantity of RBs supported for the one or more PUCCH formats. The operations of 1510 may be performed in accordance with examples as disclosed herein. In some examples, aspects of the operations of 1510 may be performed by a PUCCH manager 1130 as described with reference to FIG. 11.

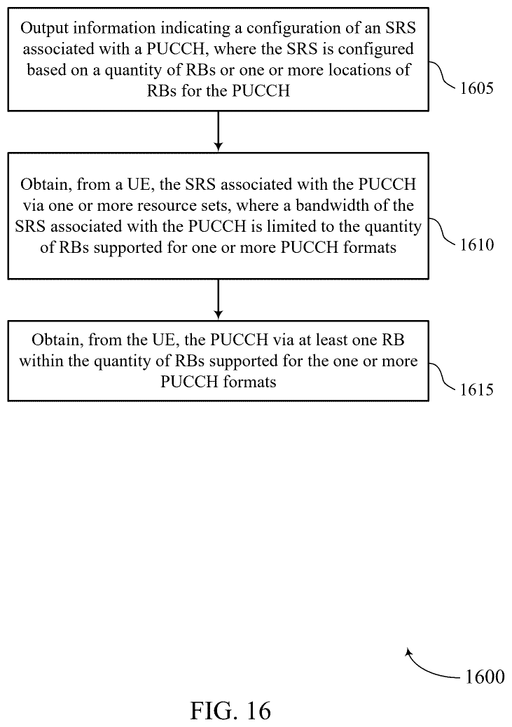

FIG. 16 shows a flowchart illustrating a method 1600 that supports enhancements for uplink control channels in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include outputting information indicating a configuration of an SRS associated with a PUCCH, where the SRS is configured based on a quantity of RBs or one or more locations of one or more RBs for the PUCCH. The operations of 1605 may be performed in accordance with examples as disclosed herein. In some examples, aspects of the operations of 1605 may be performed by a configuration manager 1135 as described with reference to FIG. 11.

At 1610, the method may include obtaining, from a UE, the SRS associated with the PUCCH via one or more resource sets. In some examples, a bandwidth of the SRS associated with the PUCCH may be limited to the quantity of RBs supported for one or more PUCCH formats. The operations of 1610 may be performed in accordance with examples as disclosed herein. In some examples, aspects of the operations of 1610 may be performed by an SRS manager 1125 as described with reference to FIG. 11.

At 1615, the method may include obtaining, from the UE, the PUCCH via at least one RB within the quantity of RBs supported for the one or more PUCCH formats. The operations of 1615 may be performed in accordance with examples as disclosed herein. In some examples, aspects of the operations of 1615 may be performed by a PUCCH manager 1130 as described with reference to FIG. 11.

The following provides an overview of aspects of the present disclosure:

Aspect 1: A method for wireless communications by a UE, comprising: transmitting, to a network entity, an SRS associated with a PUCCH via one or more resource sets; and transmitting, to the network entity, the PUCCH via at least one RB within a quantity of RBs supported for one or more PUCCH formats.

Aspect 2: The method of aspect 1, wherein a bandwidth of the SRS associated with the PUCCH is limited to the quantity of RBs supported for the one or more PUCCH formats.

Aspect 3: The method of any of aspects 1 through 2, wherein transmitting the SRS associated with the PUCCH comprises: transmitting the SRS via at least one RB that overlaps in frequency with the at least one RB utilized to communicate the PUCCH.

Aspect 4: The method of any of aspects 1 through 3, further comprising: receiving information indicating a configuration of the SRS associated with the PUCCH, wherein the SRS is configured based at least in part on the quantity of RBs or one or more locations of one or more RBs for the PUCCH.

Aspect 5: The method of any of aspects 1 through 4, wherein the SRS is independent of a second SRS associated with a PUSCH.

Aspect 6: The method of any of aspects 1 through 5, further comprising: receiving a TPMI or a TCI for the PUCCH, wherein the TPMI or TCI is based at least in part on the SRS associated with the PUCCH.

Aspect 7: The method of any of aspects 1 through 5, further comprising: receiving a TPMI or a TCI for the PUCCH, wherein the TPMI or the TCI for the PUCCH is received via DCI, and wherein a precoding matrix for the PUCCH is independent from a precoding matrix for a PUSCH or is equal to a precoding matrix for the PUSCH.

Aspect 8: The method of any of aspects 1 through 7, further comprising: transmitting, previous to transmitting the PUCCH, a PUSCH utilizing a port, wherein the PUCCH is transmitted utilizing the port that was utilized for transmission of the PUSCH.

Aspect 9: The method of any of aspects 1 through 8, wherein transmitting the PUCCH comprises: transmitting the PUCCH based at least in part on a precoding matrix that varies based at least in part on a frequency associated with an RE, an RB, or a PRG.

Aspect 10: The method of any of aspects 1 through 9, further comprising: communicating an indication of a time delay across antennas for the PUCCH, wherein the time delay is based at least in part on a PUCCH format, the quantity of RBs, or a payload of the PUCCH, and wherein the PUCCH is transmitted based at least in part on the time delay.

Aspect 11: The method of aspect 10, further comprising: receiving a request for the indication of the time delay across the antennas for the PUCCH, wherein communicating the indication of the time delay is based at least in part on the request.

Aspect 12: The method of any of aspects 1 through 11, wherein transmitting the PUCCH comprises: transmitting the PUCCH with a transmission scheme that is based at least in part on a quantity of RBs utilized for transmission of the PUCCH.

Aspect 13: The method of any of aspects 1 through 12, further comprising: communicating an indication of a time delay across antennas for the SRS associated with the PUCCH, wherein the SRS and the PUCCH are transmitted based at least in part on the time delay.

Aspect 14: The method of any of aspects 1 through 13, further comprising: transmitting a PHR associated with the PUCCH, wherein the PHR is independent from a PHR associated with a PUSCH.

Aspect 15: The method of any of aspects 1 through 14, further comprising: receiving an SSB; and transmitting, based at least in part on receiving the SSB, an indication of one or more recommended resources for transmitting the PUCCH, wherein the indication indicates a recommended quantity of repetitions for the PUCCH, one or more recommended PUCCH formats, a recommended quantity of symbols, or a recommended quantity of RBs.

Aspect 16: A method for wireless communications by a network entity, comprising: obtaining, from a UE, an SRS associated with a PUCCH via one or more resource sets; and obtaining, from the UE, the PUCCH via at least one RB within a quantity of RBs supported for one or more PUCCH formats.

Aspect 17: The method of aspect 16, wherein a bandwidth of the SRS associated with the PUCCH is limited to the quantity of RBs supported for one or more PUCCH formats.

Aspect 18: The method of any of aspects 16 through 17, wherein obtaining the SRS associated with the PUCCH comprises: obtaining the SRS via at least one RB that overlaps in frequency with the at least one RB utilized to communicate the PUCCH.

Aspect 19: The method of any of aspects 16 through 18, further comprising: outputting information indicating a configuration of the SRS associated with the PUCCH, wherein the SRS is configured based at least in part on the quantity of RBs or one or more locations of one or more RBs for the PUCCH.

Aspect 20: The method of any of aspects 16 through 19, wherein the SRS is independent of a second SRS associated with a PUSCH.

Aspect 21: The method of any of aspects 16 through 20, further comprising: outputting a TPMI or a TCI for the PUCCH, wherein the TPMI or TCI is based at least in part on the SRS associated with the PUCCH.

Aspect 22: The method of any of aspects 16 through 20, further comprising: outputting a TPMI or a TCI for the PUCCH, wherein the TPMI or the TCI for the PUCCH is received via DCI, and wherein a precoding matrix for the PUCCH is independent from a precoding matrix for a PUSCH or is equal to a precoding matrix for the PUSCH.

Aspect 23: The method of any of aspects 16 through 22, further comprising: obtaining, previous to obtaining the PUCCH, a PUSCH from a port, wherein the PUCCH is received from the port that was utilized for the PUSCH.

Aspect 24: The method of any of aspects 16 through 23, wherein obtaining the PUCCH comprises: obtaining the PUCCH based at least in part on a precoding matrix that varies based at least in part on a frequency associated with an RE, an RB, or a PRG.

Aspect 25: The method of any of aspects 16 through 24, further comprising: communicating an indication of a time delay across antennas for the PUCCH, wherein the time delay is based at least in part on a PUCCH format, the quantity of RBs, or a payload of the PUCCH, and wherein the PUCCH is transmitted based at least in part on the time delay.

Aspect 26: The method of aspect 25, further comprising: outputting a request for the indication of the time delay across the antennas for the PUCCH, wherein communicating the indication of the time delay is based at least in part on the request.

Aspect 27: The method of any of aspects 16 through 26, wherein obtaining the PUCCH comprises: obtaining the PUCCH with a transmission scheme that is based at least in part on a quantity of RBs utilized for transmission of the PUCCH.

Aspect 28: The method of any of aspects 16 through 27, further comprising: communicating an indication of a time delay across antennas for the SRS associated with the PUCCH, wherein the SRS and the PUCCH are transmitted based at least in part on the time delay.

Aspect 29: The method of any of aspects 16 through 28, further comprising: obtaining a PHR associated with the PUCCH, wherein the PHR is independent from a PHR associated with a PUSCH.

Aspect 30: The method of any of aspects 16 through 29, further comprising: outputting an SSB; and obtaining, based at least in part on outputting the SSB, an indication of one or more recommended resources for obtaining the PUCCH, wherein the indication indicates a recommended quantity of repetitions for the PUCCH, one or more recommended PUCCH formats, a recommended quantity of symbols, or a recommended quantity of RBs.

Aspect 31: A UE comprising one or more memories storing processor-executable code, and one or more processors coupled with the one or more memories and individually or collectively operable to execute the code to cause the UE to perform a method of any of aspects 1 through 15.

Aspect 32: A UE comprising at least one means for performing a method of any of aspects 1 through 15.

Aspect 33: A non-transitory computer-readable medium storing code the code comprising instructions executable by one or more processors to perform a method of any of aspects 1 through 15.

Aspect 34: A network entity comprising one or more memories storing processor-executable code, and one or more processors coupled with the one or more memories and individually or collectively operable to execute the code to cause the network entity to perform a method of any of aspects 16 through 30.

Aspect 35: A network entity comprising at least one means for performing a method of any of aspects 16 through 30.

Aspect 36: A non-transitory computer-readable medium storing code the code comprising instructions executable by one or more processors to perform a method of any of aspects 16 through 30.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit, to a network entity, a sounding reference signal (SRS) associated with a physical uplink control channel (PUCCH) via one or more resource sets; and
transmit, to the network entity, the PUCCH via at least one resource block (RB) within a quantity of RBs supported for one or more PUCCH formats.

2. The UE of claim 1, wherein a bandwidth of the SRS associated with the PUCCH is limited to the quantity of RBs supported for the one or more PUCCH formats.

3. The UE of claim 1, wherein, to transmit the SRS associated with the PUCCH, the one or more processors are individually or collectively operable to execute the code to cause the UE to:
transmit the SRS via at least one RB that overlaps in frequency with the at least one RB utilized to communicate the PUCCH.

4. The UE of claim 1, wherein the one or more processors are individually or collectively further operable to execute the code to cause the UE to:
receive information indicating a configuration of the SRS associated with the PUCCH, wherein the SRS is configured based at least in part on the quantity of RBs or one or more locations of one or more RBs for the PUCCH.

5. The UE of claim 1, wherein the SRS is independent of a second SRS associated with a physical uplink shared channel (PUSCH).

6. The UE of claim 1, wherein the one or more processors are individually or collectively further operable to execute the code to cause the UE to:
receive a transmitted precoding matrix indicator (TPMI) or a transmission configuration indicator (TCI) for the PUCCH, wherein the TPMI or TCI is based at least in part on the SRS associated with the PUCCH.

7. The UE of claim 1, wherein the one or more processors are individually or collectively further operable to execute the code to cause the UE to:
transmit, previous to transmitting the PUCCH, a physical uplink shared channel (PUSCH) utilizing a port, wherein the PUCCH is transmitted utilizing the port that was utilized for transmission of the PUSCH.

8. The UE of claim 1, wherein, to transmit the PUCCH, the one or more processors are individually or collectively operable to execute the code to cause the UE to:
transmit the PUCCH based at least in part on a precoding matrix that varies based at least in part on a frequency associated with a resource element (RE), an RB, or a precoding resource block group (PRG).

9. The UE of claim 1, wherein the one or more processors are individually or collectively further operable to execute the code to cause the UE to:
communicate an indication of a time delay across antennas for the PUCCH, wherein the time delay is based at least in part on a PUCCH format, the quantity of RBs, or a payload of the PUCCH, and wherein the PUCCH is transmitted based at least in part on the time delay.

10. The UE of claim 9, wherein the one or more processors are individually or collectively further operable to execute the code to cause the UE to:
receive a request for the indication of the time delay across the antennas for the PUCCH, wherein communicating the indication of the time delay is based at least in part on the request.

11. The UE of claim 1, wherein, to transmit the PUCCH, the one or more processors are individually or collectively operable to execute the code to cause the UE to:
transmit the PUCCH with a transmission scheme that is based at least in part on a quantity of RBs utilized for transmission of the PUCCH.

12. The UE of claim 1, wherein the one or more processors are individually or collectively further operable to execute the code to cause the UE to:
communicate an indication of a time delay across antennas for the SRS associated with the PUCCH, wherein the SRS and the PUCCH are transmitted based at least in part on the time delay.

13. The UE of claim 1, wherein the one or more processors are individually or collectively further operable to execute the code to cause the UE to:
transmit a power headroom report (PHR) associated with the PUCCH, wherein the PHR is independent from a PHR associated with a PUSCH.

14. The UE of claim 1, wherein the one or more processors are individually or collectively further operable to execute the code to cause the UE to:
receive a synchronization signal block (SSB); and
transmit, based at least in part on receiving the SSB, an indication of one or more recommended resources for transmitting the PUCCH, wherein the indication indicates a recommended quantity of repetitions for the PUCCH, one or more recommended PUCCH formats, a recommended quantity of symbols, or a recommended quantity of RBs.

15. A network entity, comprising:
one or more memories storing processor-executable code; and
one or more processors coupled with the one or more memories and individually or collectively operable to execute the code to cause the network entity to:
obtain, from a user equipment (UE), a sounding reference signal (SRS) associated with a physical uplink control channel (PUCCH) via one or more resource sets; and
obtain, from the UE, the PUCCH via at least one resource block (RB) within a quantity of RBs supported for one or more PUCCH formats.

16. The network entity of claim 15, wherein a bandwidth of the SRS associated with the PUCCH is limited to the quantity of RBs supported for the one or more PUCCH formats.

17. The network entity of claim 15, wherein, to obtain the SRS associated with the PUCCH, the one or more processors are individually or collectively operable to execute the code to cause the network entity to:
obtain the SRS via at least one RB that overlaps in frequency with the at least one RB utilized to communicate the PUCCH.

18. The network entity of claim 15, wherein the one or more processors are individually or collectively further operable to execute the code to cause the network entity to:
output information indicating a configuration of the SRS associated with the PUCCH, wherein the SRS is configured based at least in part on the quantity of RBs or one or more locations of one or more RBs for the PUCCH.

19. The network entity of claim 15, wherein the SRS is independent of a second SRS associated with a physical uplink shared channel (PUSCH).

20. The network entity of claim 15, wherein the one or more processors are individually or collectively further operable to execute the code to cause the network entity to:
output a transmitted precoding matrix indicator (TPMI) or a transmission configuration indicator (TCI) for the PUCCH, wherein the TPMI or TCI is based at least in part on the SRS associated with the PUCCH.

21. The network entity of claim 15, wherein the one or more processors are individually or collectively further operable to execute the code to cause the network entity to:
obtain, previous to obtaining the PUCCH, a physical uplink shared channel (PUSCH) from a port, wherein the PUCCH is received from the port that was utilized for the PUSCH.

22. The network entity of claim 15, wherein, to obtain the PUCCH, the one or more processors are individually or collectively operable to execute the code to cause the network entity to:
obtain the PUCCH based at least in part on a precoding matrix that varies based at least in part on a frequency associated with a resource element (RE), an RB, or a precoding resource block group (PRG).

23. The network entity of claim 15, wherein the one or more processors are individually or collectively further operable to execute the code to cause the network entity to:
communicate an indication of a time delay across antennas for the PUCCH, wherein the time delay is based at least in part on a PUCCH format, the quantity of RBs, or a payload of the PUCCH, and wherein the PUCCH is transmitted based at least in part on the time delay.

24. The network entity of claim 23, wherein the one or more processors are individually or collectively further operable to execute the code to cause the network entity to:
output a request for the indication of the time delay across the antennas for the PUCCH, wherein communicating the indication of the time delay is based at least in part on the request.

25. The network entity of claim 15, wherein, to obtain the PUCCH, the one or more processors are individually or collectively operable to execute the code to cause the network entity to:
obtain the PUCCH with a transmission scheme that is based at least in part on a quantity of RBs utilized for transmission of the PUCCH.

26. The network entity of claim 15, wherein the one or more processors are individually or collectively further operable to execute the code to cause the network entity to:
communicate an indication of a time delay across antennas for the SRS associated with the PUCCH, wherein the SRS and the PUCCH are transmitted based at least in part on the time delay.

27. The network entity of claim 15, wherein the one or more processors are individually or collectively further operable to execute the code to cause the network entity to:
obtain a power headroom report (PHR) associated with the PUCCH, wherein the PHR is independent from a PHR associated with a PUSCH.

28. The network entity of claim 15, wherein the one or more processors are individually or collectively further operable to execute the code to cause the network entity to:
output a synchronization signal block (SSB); and
obtain, based at least in part on outputting the SSB, an indication of one or more recommended resources for obtaining the PUCCH, wherein the indication indicates a recommended quantity of repetitions for the PUCCH, one or more recommended PUCCH formats, a recommended quantity of symbols, or a recommended quantity of RBs.

29. A method for wireless communications by a user equipment (UE), comprising:
transmitting, to a network entity, a sounding reference signal (SRS) associated with a physical uplink control channel (PUCCH) via one or more resource sets; and
transmitting, to the network entity, the PUCCH via at least one resource block (RB) within a quantity of RBs supported for one or more PUCCH formats.

30. A method for wireless communications by a network entity, comprising:
obtaining, from a user equipment (UE), a sounding reference signal (SRS) associated with a physical uplink control channel (PUCCH) via one or more resource sets; and
obtaining, from the UE, the PUCCH via at least one resource block (RB) within a quantity of RBs supported for one or more PUCCH formats.
